(19) United States
(12) Patent Application Publication
(10) Pub. No.: US 2024/0160834 A1
(43) Pub. Date: May 16, 2024

(54) AUTOMATED DOCUMENT FORMATING FOR ELECTRONIC SIGNATURE

(71) Applicant: Wells Fargo Bank, N.A., San Francisco, CA (US)

(72) Inventors: Ravi Kanth Maganti, Waxhaw, NC (US); Mounir Laaraj, LaSalle (CA); Michael E. Blair, Boonsboro, MD (US); William Geyer Hara, Alameda, CA (US); Ujwal Shrestha, San Antonio, TX (US)

(21) Appl. No.: 17/446,795

(22) Filed: Sep. 2, 2021

(51) Int. Cl. G06F 40/143; G06F 21/62; G06F 40/186

(52) U.S. Cl. CPC G06F 40/143; G06F 21/6209; G06F 40/186

(57) ABSTRACT

Systems and methods may generally be used to improve document formatting for e-signatures. An example method may include using a processor, for example, for receiving a fixed-layout flat format document, and identifying a set of styles to apply to the fixed-layout flat format document. The method may include constructing a HyperText Markup Language (HTML)-formatted document from data extracted from the fixed-layout flat format document and according to the set of styles, and sending the HTML-formatted document to an e-signature platform.

### BACKGROUND

Documents often need a user to sign in order to comply with laws, such as for contracts, banking, official government documents, etc. Electronic signatures (e-signatures) are increasingly being used to replace hand signing. E-signatures are often more efficient when a document is already digital, because printing, signing, and scanning is a time-consuming process. Various technologies exist to support applying e-signatures, such as using a portable document format (PDF), a HyperText Markup Language (HTML) format, or the like. A specific e-signature program may be used to increase security.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for structing a document in a different format for e-signing in accordance with some embodiments.

FIG. 2 illustrates a block diagram to extract information and construct a HyperText Markup Language (HTML)-formatted document for e-signing in accordance with some embodiments.

FIG. 3 illustrates a block diagram with content shown in two different formats in accordance with some embodiments.

FIG. 4 illustrates a flowchart showing a technique for reconstructing a document in a different format for e-signing in accordance with some embodiments.

FIG. 5 illustrates generally an example of a block diagram of a machine upon which any one or more of the techniques discussed herein may perform in accordance with some embodiments.

### DETAILED DESCRIPTION

The systems and methods described herein may be used to improve document formatting for e-signatures. As discussed above, e-signatures are popular and convenient, and they may be used on a wide variety of documents, such as contracts, governmental forms, banking forms, health forms, etc. Although e-signature use is popular, it is often challenging to navigate a fixed-layout flat format document, typically used on e-signature platforms. Navigation (e.g., reading, checking boxes, signing, etc.) becomes especially difficult for users when the e-signature is applied on a smaller screen device, such as a mobile phone, a tablet, a small laptop, or the like.

The systems and methods discussed herein may create a HyperText Markup Language (HTML)-formatted document from data extracted from a fixed-layout flat format document, such as according to a style (e.g., a set of styles, such as via a style sheet formatted according to a Cascading Style Sheets (CSS) standard). The HTML-formatted document may be sent to an e-signature platform for receiving an e-signature. The HTML-formatted document, once signed, may be saved as an HTML-formatted signed document, or as a fixed-layout flat format document, such as in a Portable Document Format (PDF) according to International Organization for Standardization (ISO) 32000 standards.

In an example, a method may include receiving a fixed-layout flat format document. The method may include identifying a set of styles, such as based on a user, an organization, a sub-organization, a message or indication (e.g., received with or separately from the fixed-layout flat format document), obtained from a database, or the like. Using information in the fixed-layout flat format document and the set of styles, a HTML-formatted document may be constructed. The HTML-formatted document may be output for e-signature, for example by being sent or saved (e.g., in an email, via an API, etc.) to an e-signature platform.

In an example, a mobile responsive design is provided for e-signature capture with style configurations based on organization, line of business, client, etc. An e-signature platform may include a software-as-a-service (SaaS) platform or other service for e-signatures from users. E-signature platforms currently fail to create mobile responsive designs from PDFs. Further, PDFs used for e-signature documents may not include style options. For example, instead of creating a true HTML representation of a PDF, the e-signature platform generally just makes an image of the PDF. This creates a variety of problems such as a poor user experience on mobile devices as well as making it challenging for screen readers used by peoples with disabilities.

An e-signature platform may not offer any, or only limited, mobile responsive design. The systems and methods described herein provide an automated technique that takes a PDF or other fixed-layout formatted document and generates a corresponding HTML document or other flexible-layout formatted document. The flexible-layout document may include an applied style, such as according to a line of business, organization, or user preference. The flexible-layout document may be used by an e-signature provider to present a mobile responsive design experience for signing.

An example technique includes receiving a PDF document from a line of business (LOB) with style and preferences from the LOB. For example, the LOB may indicate a label for a component, a font, a color, a number of columns, a table arrangement, etc. A preference may include changing table formatting, for example from two-columns as opposed to shrinking cells or font size. In some examples, the LOB may be prevented from styling certain aspects of the document (e.g., to prevent text from being hidden). For example, an organization may provide a set of pre-approved colors, font sizes, etc., the LOB can use. After identifying the styles (e.g., from a cascading style sheet), a responsive HTML document may be generated with the styles using the PDF content. The HTML document may be generated from a library using a PDF tag tree of the PDF document. In an example, the LOB may preview the HTML document before finalizing or sending to the e-signature platform, which gives the LOB the opportunity to change styles, preferences, etc. The responsive HTML document may be sent with styles to the e-signature platform. The e-signature platform may present the responsive HTML document to a user for signature. The e-signature platform may send or save the responsive HTML document, or may convert the responsive HTML document into a new signed PDF, for storage or sending. In an example, a user from the line of business may receive a signed. PDF from the e-signature platform.

When using a PDF for an e-signature, some issues may occur, such as needing to use pinch and zoom to read content, slow loading times for large documents, needing to load multiple images on a mobile devices, truncated tables, checkboxes displayed but not selectable, need for side scrolling, or the like. Using the techniques described herein to generate a styled HTML from a PDF before e-signature provides technical advantages for display, such as content is readable even on smaller devices, removing the need to use pinch and zoom, allowing users to increase fonts, removing the requirement of having two distinct views to support accessibility view, optimizing large documents display by collapsing sections for quicker loading times, uniquely styling content, etc. The systems and methods described herein provide improvements to technical problems of e-signature document presentation, which fix broken documents, speed up loading, use less memory, provide for faster processing, or the like. In some examples, HTML document generation with styles from a PDF may include supporting PDFs with images, tables, or links, generating an HTML document that includes all form fields with properties from the PDF, or generating an HTML accessible document when the PDF is tagged for accessibility.

In an example, generating an HTML document from a PDF document with styling includes extracting accessibility tags from the PDF, generating a styled. HTML from the PDF tags and content by applying the styling. The styling may be applied based on a user configuration, via a web service, via an API, or the like. The styled HTML may be responsive to change based on output screen size.

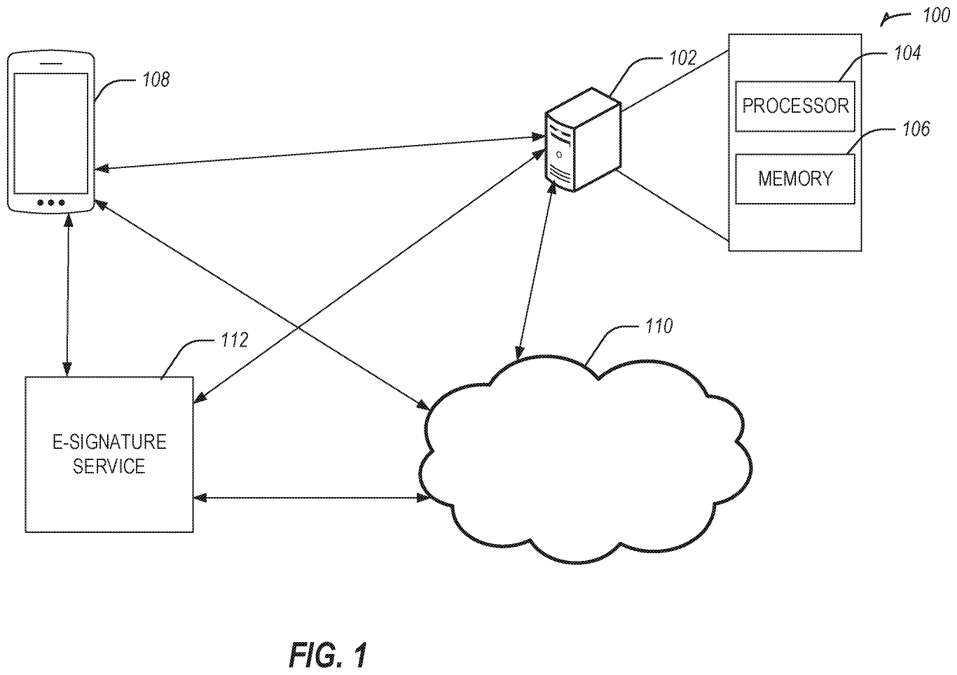

FIG. 1 illustrates a system 100 for structing a document in a different format for e-signing in accordance with some embodiments. In FIG. 1, the system 100 includes a user computer 102, a server/cloud device 110, an e-signature service 112, and a mobile device 108. The user computer 102 includes a processor 104 and memory 106 for processing and storing instructions.

The user computer 102 may be used to select a PDF or other fixed-layout document, and select or identify a set of styles. Once selected, the PDF and the set of styles may be used to generate a styled HTML document, either at the user computer 102 or at the server/cloud device 110 after the PDF and an indication of the set of styles is sent to the server/cloud device 110. Whichever device generates the styled HTML document may send it to the e-signature service 112. The e-signature service 112 may send the styled. HTML document to the mobile device 108 for e-signing. After the styled HTML document is e-signed, the mobile device 108 may send it (or a PDF document created from the styled HTML document at the mobile device 108) to the e-signature service 112, to the server/cloud device 110, or directly to the user computer 102. When the document is sent from the mobile device 108 to the e-signature service 112 or the server/cloud 110, the document may be stored (and if the document was the styled HTML, it may be converted to PDF and stored as a signed PDF). The document may be sent to the user computer 102 from the e-signature service 112 or the server/cloud device 110.

Any of the user computers 102, mobile device 108, server/cloud device 110, or e-signature service 112 may generate the styled HTML document from a PDF and set of styles, and any of them may convert a signed styled HTML document to a signed PDF.

The server/cloud device 110 or the user computer 102 may include a database or other storage, such as to store a library. The library may be used as a service, for example as part of an enterprise as a service solution for generating a styled HTML document from a PDF. The service may create the HTML, representation of the PDF document, provide the HTML document when requested by a calling application (e.g., of the user computer 102, the e-signature service 112, etc.), for viewing in a user interface. An action performed on the content in the HTML document (e.g., checking a checkbox, selecting a radio button, adding a signature, adding initials, or the like) may be translated to actions on a corresponding PDF document. The corresponding PDF document may be shared to the mobile device 108, the user computer 102 or elsewhere after completion (e.g., when a user selects that the actions are completed).

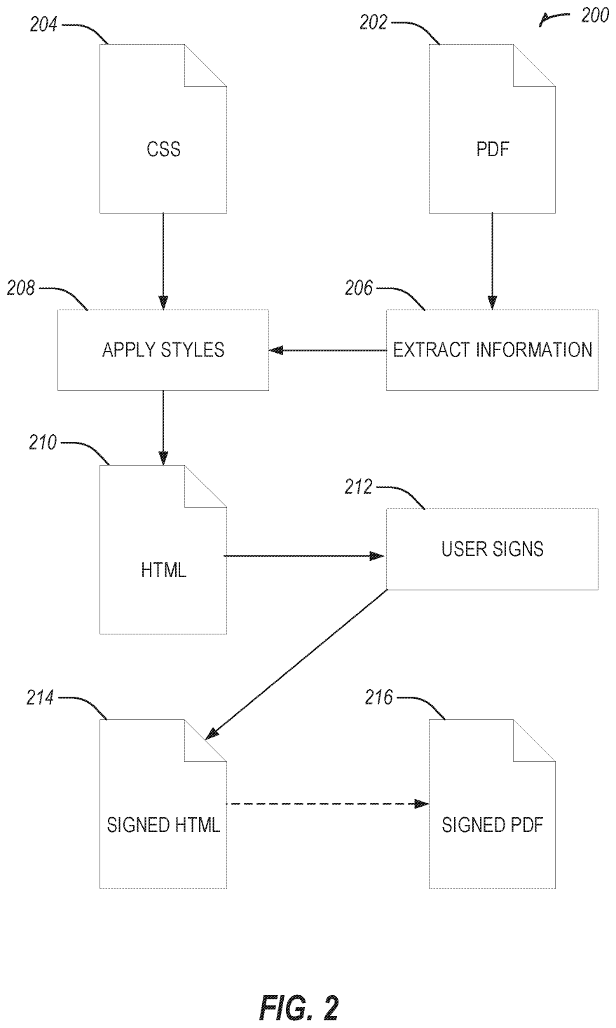

FIG. 2 illustrates a block diagram 200 to extract information and construct a HTML formatted document for e-signing in accordance with some embodiments. The block diagram 200 shows document collection and creation components, at each of several stages of generation of the HTML-formatted document. In a first stage, a PDF-formatted document 202 is received, retrieved, identified, etc. In this first stage, a CSS document 204 is identified, such as from a message including the PDF 202, from a stored user preference, from a group style, from a library or database, etc.

At a second stage, information is extracted at block 206 from the PDF 202, such as using PDF tags, in a tag tree of the PDF 202, from content of the PDF 202, etc. The extracted information from block 206 is used with the styles of the CSS 204 at block 208 to apply the styles to the extracted information. Once the styles are applied to the extracted information, an HTML-formatted document 210 is created. The HTML document 210 may be sent to an e-signature platform for singing by a user.

At a third stage, the user may sign the HTML document at block 212. The signed HTML document 214 may be generated. At a fourth stage, a signed PDF 216 may be generated by converting the signed HTML document 214 to a PDF format, while retaining changes made by a user in block 212.

The HTML document 210 may include an HTML frame that is created using a PDF tag tree for the PDF 202. The tag equivalent of a PDF Object may be mapped to an HTML tag to ensure the output is ADA compatible HTML. When PDF text, images, tables, or the like are extracted, text font properties may be carried over from PDF text to ensure the appearance of the HTML output closely or exactly matches the PDF font.

PDF Form Elements may be extracted from the PDF 202 using PDF fields. The extracted elements may be converted to HTML input fields based on type of fields. Any values that are present on the PDF form elements may be set as values on the HTML output. In an example, a signature HTML tag may be generated based on a PDF signature tag, or a component of a PDF indicated for a signature (e.g., a line, after the word “signed”, or the like). The signature HTML tag may be unique to the service as a placeholder for a clients to add a signature button or other input button for selection.

HTML tags are placed in positions corresponding to positions in a PDF of text, images, tables, etc. In some examples, a position tolerance may be added to the HTML tags to ensure that an HTML position is visible and presented in an alignment corresponding to the PDF objects.

PDF text or form field alignments may be used to generate corresponding text or form fields on HTML output. In an example, a position tolerance with alignment predictability functional implementation is used to adjust the HTML output. This position tolerance may be based on a fault tolerance and alignment predictability function to set alignment based on PDF page size and apply a corresponding change to a given HTML page size. The HTML components may be adjusted from their PDF alignments based on HTML page size, which may in turn be based on display screen size. PDF objects may be extracted based on generated classes stored in a custom library to support the conversion process.

Components of a PDF or HTML document that may be arranged, modified, or otherwise stylized include headers, buttons, styles, lists, tables, positions of tables, or the like. Styles applied at block 208 may be user selectable from a particular list of styes (e.g., 10 fields, with drop down lists, radio buttons, check boxes, icons, etc.) in this example, the CSS 204 may be automatically generated from the user selections. In this example, the CSS 204 is limited to applicable styles, and non-usable styles may be prevented from being selected or applied to the HTML document 210. For example, some CSS styles may not be usable with an e-signature platform (e.g., hidden text, some fonts, etc.) and may be prevented from use in the CSS 204 for applying styles at block 208. The CSS 204 may be generated in another example from a template (e.g., a stored CSS document or a stored set of style selections). The template may be user specific, line of business specific, organization specific, or the like. In an example, the CSS 204 may be validated for formatting accuracy.

The HTML document 210 may be a single document usable for different devices or screen sizes that is automatically sized for the device or screen size. In contrast, a PDF may have static components or page sizes that may not be automatically sized for different devices or screen sizes.

In an example, the CSS document 204 may code to style the HTML document 210. Below is some example pseudocode shown for illustration.

```
<!DOCTYPE html>
<html>
<title>Example CSS for PDF to HTML</title>
<meta name=“viewport” content=“width=device-width, initial-scale=1”>
<link rel=“stylesheet” href=“pdf_to_html.css”>
<body>
<div class=“container”>
<h1>Text</h1>
  <div class=“text”>
    <h2>Example</h2>
    <p>Some text</p>
  </div>
</div>
</body>
</html>
```

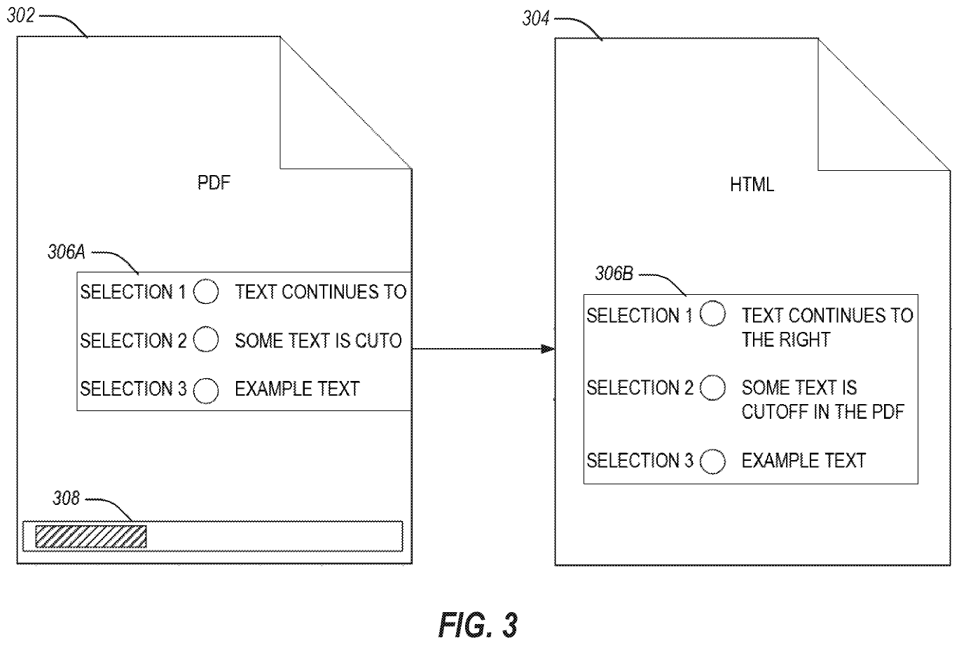

FIG. 3 illustrates a block diagram with content shown in two different formats in accordance with some embodiments. FIG. 3 shows an example PDF document 302 and a corresponding example HTML document 304. The corresponding HTML document 304 may be generated based on the PDF document 302 and a style sheet, according to the systems and methods described herein.

The PDF document 302 includes a table 306A that is cutoff, while in the corresponding HTML document 304, the table 306B represents the same data, but without being cutoff. The PDF document 302 includes a scrollbar 308, which is inconvenient and may result in a user missing information. In the corresponding HTML document 304, the scrollbar 308 of the PDF document 302 is not needed, and thus does not appear in the HTML document 304, These improvements are illustrative, and other improvements may be present or substituted.

In an example, radio buttons in the table 306A of the PDF document 302 may not be selectable, may require additional input steps, such as manually filling in the radio buttons, etc. In the corresponding HTML document 304, the radio buttons of table 306B may be selectable (e.g., finable with a single click or button press, mutually exclusively selectable, or the like). While not shown, a signature box or block may be similarly fillable or signable with a single or multiple clicks in the HTML document 304, while not being easily finable in the PDF document 302 (e.g., require a signing application, a series of button presses or mouse clicks for signing, or the like).

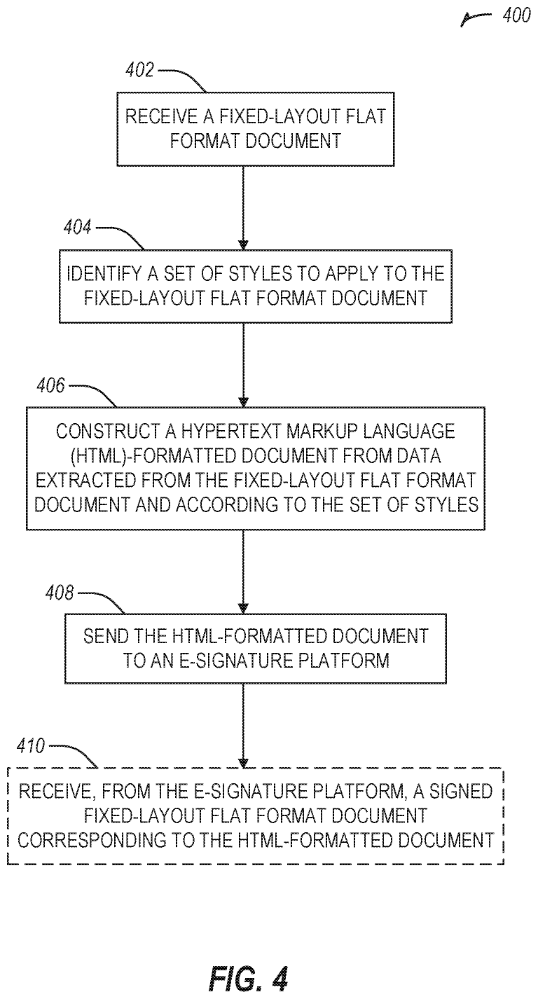

FIG. 4 illustrates a flowchart showing a technique 400 for reconstructing a document in a different format for e-signing in accordance with some embodiments. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 1.

The technique 400 includes an operation 402 to receive a fixed-layout flat format document. The fixed-layout flat faunal may include a Portable Document Format (PDF) according to International Organization for Standardization (ISO) 32000 standards.

The technique 400 includes an operation 404 to identify a set of styles to apply to the fixed-layout flat format document. The set of styles may include a style sheet, such one formatted according to a Cascading Style Sheets (CSS) standard. In an example, Operation 402 includes receiving style information, and operation 404 includes identifying the set of styles from the received style information. The style information may be received with the document in operation 402, such as in a single email, message, etc. In an example, the style information may be indicated by a sender of a message, email, etc. (e.g., the sender may be part of an organization or group with a particular specified style, or the recipient may have a stored or indicated style preconfigured).

The technique 400 includes an operation 406 to construct an HTML-formatted document from data extracted from the fixed-layout flat format document and according to the set of styles. The set of styles may be identified from a preconfigured template. In an example, operation 406 includes not using at least one style from the set of styles when the at least one style violates a standard in use, such as the CSS standard. Operation 406 may include not using at least one style from the set of styles when the at least one style, when implemented, causes text to be hidden in the Html-formatted document. In an example, operation 406 not using at least one style from the set of styles when the least one style conflicts with a primary style sheet. The primary style sheet may be an organization-wide style sheet, for example with fewer styles or more choices than the set of styles, which may be a sub-organization group style sheet. The set of styles may correspond to an account holder. The set of styles may include at least one of an account-specified style (e.g., for a company, school, or other entity), a sub-account-specified template style (e.g., for a department of a company, a classroom of a school, etc.) for a document type of the document, an individual style for a particular instance of the document, or the like. The styles may include a modification or configuration for a text box, an identifier for a component, a table (e.g., number of columns, minimum or maximum width, text wrapping, etc.), or the like.

The technique 400 includes an operation 408 to send the HTML-formatted document to an e-signature platform. Operation 508 may include sending the HTML-formatted document to the e-signature platform for signing in the HTML-format. The HTML-formatted document may be signable using a mobile device, such as a mobile phone. The HTML-format may display the document in an improved way on the mobile device when compared to the fixed-layout flat format, such as by being displayable without horizontal scrolling, without truncation of a table, or the like. Operation 408 may include sending the HTML-formatted file to an account holder (e.g., who provided the set of styles) before finalizing. The technique 400 may include, before sending the HTML-formatted file, validating the HTML-formatted file against a Cascading Style Sheets (CSS) standard and against at least one business rule. The business rule may be based on an organizational style rule, a contract rule, a user preference, etc.

The technique 400 includes an operation 410 to receive, from the e-signature platform, a signed fixed-layout flat format document corresponding to the HTMI-formatted document. In another example, the technique 400 may include receiving a signed HTML-formatted document back from the e-signature platform. In some examples, a signed document may not be sent back. In some examples, a signed document may be sent to a device, such as a signer device, a counterparty device, a device for storing the signed document, or the like.

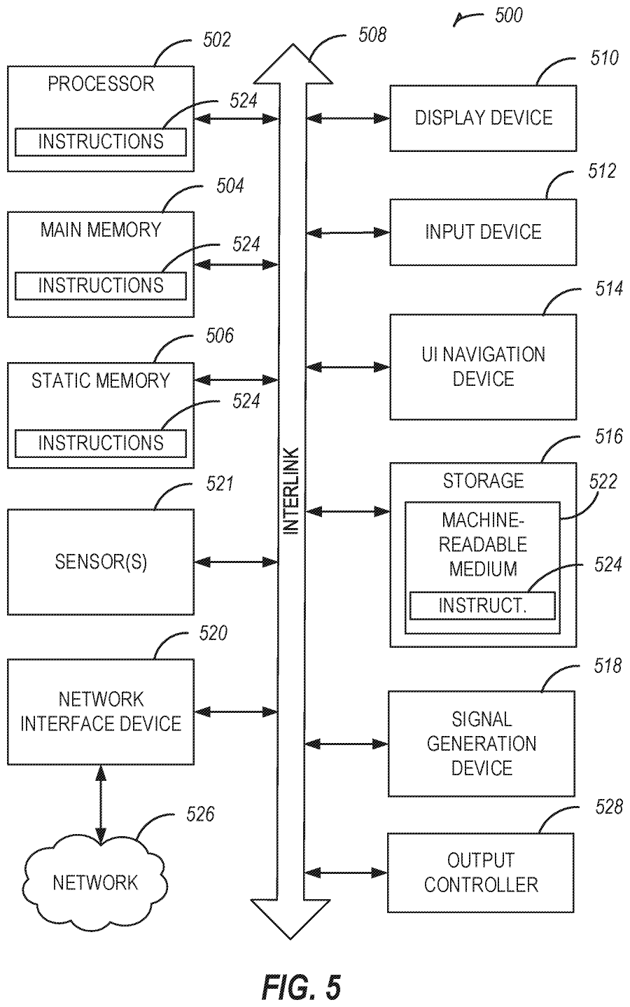

FIG. 5 illustrates generally an example of a block diagram of a machine 500 upon which any one or more of the techniques (e.g., methodologies) discussed herein may perform in accordance with some embodiments. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an intern nk (e.g., bus) 508, The machine 500 may further include a display unit 510, an alphanumeric input device 512 (e.g., a keyboard), and a user interface (UI) navigation device 514 (e.g., a mouse) In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MEMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving, at a processor, an unsigned fixed-layout flat format document; identifying a set of styles to apply to the unsigned fixed-layout flat format document; constructing, using the processor, a HyperText Markup Language (HTML)-formatted document from data extracted from the unsigned fixed-layout flat format document and according to the set of styles; sending the HTML-formatted document to an e-signature platform; and receiving, from the e-signature platform, a signed fixed-layout flat format document corresponding to the HTML-formatted document.

In Example 2, the subject matter of Example 1 includes, wherein receiving the unsigned fixed-layout flat format document includes receiving style information, and wherein identifying the set of styles includes identifying the set of styles from the received style information.

In Example 3, the subject matter of Examples 1-2 includes, wherein constructing the HTML-formatted document includes not using at least one style from the set of styles when the at least one style, when implemented, causes text to be hidden in the Html-formatted document.

In Example 4, the subject matter of Examples 1-3 includes, wherein constructing the HTML-formatted document includes not using at least one style from the set of styles when the at least one style conflicts with a primary style sheet.

In Example 5, the subject matter of Examples 1-4 includes, wherein the set of styles is identified from a style sheet formatted according to a Cascading Style Sheets (CSS) standard.

In Example 6, the subject matter of Example 5 includes, wherein constructing the HTML-formatted document includes not using at least one style from the set of styles when the at least one style violates the CSS standard.

In Example 7, the subject matter of Examples 1-6 includes, wherein the set of styles correspond to an account holder, and wherein sending the HTML-formatted document includes sending the HTML-formatted document to the account holder before finalizing.

In Example 8, the subject matter of Examples 1-7 includes, wherein a style of the set of styles is responsive to a device display size, and wherein displaying the HTML-formatted document on a particular display device includes changing the style for the HTML-formatted document based on a display size of the particular display device.

In Example 9, the subject matter of Examples 1-8 includes, wherein the set of styles include at least one of an account-specified style, a sub-account-specified template style for a document type of the document, or an individual style for a particular instance of the document.

In Example 10, the subject matter of Examples 1-9 includes, before sending the HTML-formatted document, validating the HTML-formatted document against a Cascading Style Sheets (CSS) standard and against at least one business rule.

In Example 11, the subject matter of Examples 1-10 includes, wherein the unsigned fixed-layout flat format is a Portable Document Format (PDF) according to International Organization for Standardization (ISO) 32000 standards.

Example 12 is at least one non-transitory machine-readable medium including instructions, which when executed by processing circuitry, causes the processing circuitry to perform operations to: receive a Portable Document Format (PDF) document according to International Organization for Standardization (ISO) 32000standards; identify a set of styles to apply to the PDF document; construct a HyperText Markup Language (HTML)-formatted document from data extracted from the PDF document and according to the set of styles; send the HTML-formatted document to an e-signature platform; and receive, from the e-signature platform, a signed PDF document corresponding to the HTML-formatted document.

In Example 13, the subject matter of Example 12 includes, wherein to receive the PDF document, the instructions cause the processing circuitry to perform operations to receive style information, and wherein to identify the set of styles, the instructions cause the processor to perform operations to identify the set of styles from the received style information.

In Example 14, the subject matter of Examples 12-13 includes, wherein to construct the HTML-formatted document, the instructions cause the processing circuitry to perform operations to not use at least one style from the set of styles when the at least one style, when implemented, causes text to be hidden in the Html-formatted document or when the at least one style conflicts with a primary style sheet.

In Example 15, the subject matter of Examples 12-14 includes, wherein the set of styles is identified from a style sheet formatted according to a Cascading Style Sheets (CSS) standard.

In Example 16, the subject matter of Examples 12-15 includes, wherein the set of styles are identified from a preconfigured template.

Example 17 is a method comprising: presenting a fixed-layout flat format document for display; creating a style sheet formatted according to a Cascading Style Sheets (CSS) standard corresponding to the fixed-layout flat format document from selected styles; validating that the style sheet is usable to generate a HyperText Markup Language (HTML)-formatted document from the fixed-layout flat format document; generating a template including the fixed-layout flat format document and the validated style sheet; and saving the template for use with generating HTML-formatted documents for e-signature.

In Example 18, the subject matter of Example 17 includes, wherein the fixed-layout flat format is a Portable Document Format (PDF) according to International Organization for Standardization (ISO) 32000standards.

In Example 19, the subject matter of Example 18 includes, wherein creating the style sheet includes mapping PDF tags to HTML tags.

In Example 20, the subject matter of Examples 17-19 includes, wherein saving the template includes saving the template in a library accessible via an Application Programming Interface (API) as a service.

Example 21 is a method comprising: receiving, at an e-signature platform from a service, a HyperText Markup Language (HTML)-formatted document constructed from a fixed-layout flat format document with a set of styles; presenting the HTML-formatted document to a user for signing; receiving an indication on the HTML-formatted document of an intent by the user to sign the HTML-formatted document; generating, based on the intent, a signed fixed-layout flat format document corresponding to the HTML-formatted document; and sending the signed fixed-layout flat format document to the service.

In Example 22, the subject matter of Example includes, wherein the e-signature platform operates on a mobile phone.

In Example 23, the subject matter of Examples 21-22 includes, wherein the e-signature platform renders the HTML-formatted document differently on a mobile phone than on a computer screen.

Example 24 is a method comprising: receiving, at a processor, an unsigned fixed-layout flat format document; identifying a set of styles to apply to the unsigned fixed-layout flat format document; constructing, using the processor, a flexible format document from data extracted from the unsigned fixed-layout flat format document and according to the set of styles; sending the flexible format document to an c-signature platform; and receiving, from the e-signature platform, a signed fixed-layout flat format document corresponding to the flexible format document.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving, at a processor, an unsigned fixed-layout flat format document;
receiving style information;
identifying a set of styles to apply to the unsigned fixed-layout flat format document from the received style information;
extracting content data and tag data from the unsigned fixed-layout format document, the tag data extracted by using tags in a tag tree of the unsigned fixed-layout format document;
constructing, using the processor, a styled HyperText Markup Language (HTML)-formatted document with the extracted content data from the unsigned fixed-layout flat format document and according to the set of styles, the set of styles including a modification of a component of the content data in the styled HTML-formatted document, the styled HTML-formatted document including an HTML frame created using the tag data extracted from tag tree of the unsigned fixed-layout format document, by mapping the tags in the tag tree of the unsigned fixed-layout format document to HTML tags;
sending the styled HTML-formatted document to an e-signature platform for signing by a user; and
receiving, from the e-signature platform, a signed fixed-layout flat format document corresponding to the styled HTML-formatted document, the signed fixed-layout flat format document generated from the styled HTML-formatted document by the e-signature platform using at least one style of the set of styles after the user signs the styled HTML-formatted document.

2. (canceled)

3. The method of claim 1, wherein constructing the styled HTML-formatted document includes not using at least one style from the set of styles when the at least one style, when implemented, causes text to be hidden in the styled HTML-formatted document.

4. The method of claim 1, wherein constructing the styled HTML-formatted document includes not using at least one style from the set of styles when the at least one style conflicts with a primary style sheet.

5. The method of claim 1, wherein the set of styles is identified from a style sheet formatted according to a Cascading Style Sheets (CSS) standard.

6. The method of claim 5, wherein constructing the styled HTML-formatted document includes not using at least one style from the set of styles when the at least one style violates the CSS standard.

7. The method of claim 1, wherein the set of styles correspond to an account holder, and wherein sending the styled HTML-formatted document includes sending the styled HTML-formatted document to the account holder before finalizing.

8. The method of claim 1, wherein a style of the set of styles is responsive to a device display size, and wherein displaying the styled HTML-formatted document on a particular display device includes changing the style for the styled HTML-formatted document based on a display size of the particular display device.

9. The method of claim 1, wherein the set of styles include at least one of an account-specified style, a sub-account-specified template style for a document type of the document, or an individual style for a particular instance of the document.

10. The method of claim 1, further comprising, before sending the styled HTML-formatted document, validating the styled HTML-formatted document against a Cascading Style Sheets (CSS) standard and against at least one business rule.

11. The method of claim 1, wherein the unsigned fixed-layout flat format is a Portable Document Format (PDF) according to International Organization for Standardization (ISO) 32000 standards.

12. At least one non-transitory machine-readable medium including instructions, which when executed by processing circuitry, causes the processing circuitry to perform operations to:
receive a Portable Document Format (PDF) document according to International Organization for Standardization (ISO) 32000 standards;
receive style information;
identify a set of styles to apply to the PDF document from the received style information;
extract content and tag data from the PDF document, the tag data extracted by using PDF tags in a PDF tag tree of the PDF document;
construct a styled HyperText Markup Language (HTML)-formatted document with extracted content data from the PDF document and according to the set of styles, the set of styles including a modification of a component of the content data in the styled HTML-formatted document, the styled HTML-formatted document including an HTML frame created using the tag data extracted from the PDF document by mapping the PDF tags in the PDF tag tree of the PDF document to HTML tags;
send the styled HTML-formatted document to an e-signature platform for signing by a user; and
receive, from the e-signature platform, a signed PDF document corresponding to the styled HTML-formatted document, the signed PDF document generated from the styled HTML-formatted document by the e-signature platform using at least one style of the set of styles after the user signs the styled HTML-formatted document.

13. (canceled)

14. The machine-readable medium of claim 12, wherein to construct the styled HTML-formatted document, the instructions cause the processing circuitry to perform operations to not use at least one style from the set of styles when the at least one style, when implemented, causes text to be hidden in the Html-formatted document or when the at least one style conflicts with a primary style sheet.

15. The machine-readable medium of claim 12, wherein the set of styles is identified from a style sheet formatted according to a Cascading Style Sheets (CSS) standard.

16. The machine-readable medium of claim 12, wherein the set of styles are identified from a preconfigured template.

17. A method comprising:
presenting a fixed-layout flat format document for display;
creating a style sheet formatted according to a Cascading Style Sheets (CSS) standard corresponding to the fixed-layout flat format document from selected styles;
validating that the style sheet is usable to generate a HyperText Markup Language (HTML)-formatted document from the fixed-layout flat format document;
generating a template including the fixed-layout flat format document and the validated style sheet; and
saving the template for use with generating HTML-formatted documents for e-signature.

18. The method of claim 17, wherein the fixed-layout flat format is a Portable Document Format (PDF) according to International Organization for Standardization (ISO) 32000 standards.

19. The method of claim 18, wherein creating the style sheet includes mapping PDF tags to HTML tags.

20. The method of claim 17, wherein saving the template includes saving the template in a library accessible via an Application Programming Interface (API) as a service.
